(19) United States
(12) Patent Application Publication
(10) Pub. No.: US 2014/0052637 A1
(43) Pub. Date: Feb. 20, 2014

(54) PORTABLE DEVICE WIRELESS READER AND PAYMENT TRANSACTION TERMINAL SECURE MEMORY FUNCTIONALITY

(71) Applicant: GOOGLE INC., Mountain View, CA (US)

(72) Inventors: Sarel Kobus Jooste, Novato, CA (US); Andrew David Rogers, Seattle, WA (US); Robert Lieh-Yuan Tsai, San Francisco, CA (US); Martijn Franciscus Agnes Coenen, Mountain View, CA (US)

(73) Assignee: GOOGLE INC., Mountain View, CA (US)

(21) Appl. No.: 13/970,573

(22) Filed: Aug. 19, 2013

Related U.S. Application Data
(60) Provisional application No. 61/684,696, filed on Aug. 17, 2012.

(51) Int. Cl. G06Q 20/32; G06Q 20/38

(52) U.S. Cl. CPC G06Q 20/325; G06Q 20/382
USPC 705/44

(57) ABSTRACT

A user accesses an application on a reader mode device, activating a reader communication mode and disabling conflicting communication modes. The reader mode device activates a radio frequency field and creates a secure communication channel with a payment device. A secure element application on the reader mode device requests and receives payment information from a payment device. The secure element application on the reader mode device decrypts the payment information and requests account verification from the user. The secure element application on the reader mode device receives input from the user and verifies the payment information. In response to verifying the account information, the secure element application on the reader mode device encrypts the payment information and transmits it to a payment processing system. The payment processing system processes the payment transaction and transmits a notice of approved or declined transaction to the reader mode device.

### RELATED APPLICATION

This patent application claims priority under 35 U.S.C. §119 to U.S. Provisional Patent Application No. 61/684,696, filed Aug. 17, 2012 and entitled “Wireless Tag Reader and Transaction Terminal Functionality Within a Mobile Device.” The entire contents of the above-identified application are hereby fully incorporated herein by reference.

### TECHNICAL FIELD

The present disclosure relates to processing payment transactions, and more particularly to processing payment transactions using a wireless reader mode device and a wireless communication-enabled payment device with a secure memory.

### BACKGROUND

Wireless device technology incorporates proximity communications between two devices to authenticate and enable payment for goods and services over the air (OTA) or without physical connection. Near Field Communication (NFC) is an example of a proximity communication option that can enable wireless device payment technologies and that is supported by the Global System for Mobile Communications (GSM) Association. Radio frequency identification (RFID) is another wireless communication technology that can be adapted to enable NFC wireless device payment technology. NFC communication distances generally range from about 3 to about 4 inches. Such short communication distances enable secure communication between close field proximity enabled devices.

In wireless communication-enabled devices, a proximity-enabled controller (for example, an NFC controller) with an antenna is incorporated into the device with the secure contactless software applications located on a smart chip. An NFC-enabled wireless payment device enables financial transactions, ticketing, secure authentication, coupons, and other transaction for the device owner.

### SUMMARY

In certain example embodiments described herein, a method for processing payment transactions comprises a wireless reader mode device and a wireless communication-enabled payment device with a secure memory. A user initiates a payment transaction by accessing an application of the reader mode device. The application activates a reader communication mode on the reader mode device and disables any conflicting communication modes that would interfere with the payment transaction. The reader mode device activates a radio frequency (RF) field and a communication channel is established when the payment device is detected by the reader mode device. An application on the secure element of the reader mode device transmits a payment account information request to the payment device, and the payment device transmits encrypted payment account information to the application on the secure element of the reader mode device. The application on the secure element of the reader mode device decrypts the encrypted payment account information and requests verification of the identity of the user of the payment device and/or of the payment account information (for example, a personal identification number). The user enters the verification information, and the application on the secure element of the reader mode device confirms the verification.

The application on the secure element of the reader mode device encrypts the payment account information and transmits the encrypted payment account information to the application on the reader mode device, which transmits the encrypted payment account information to a payment processing system. The payment processing system processes the payment transaction and transmits a notice of approved transaction or declined transaction to the reader mode device. If the payment transaction is approved, the reader mode device displays notification of an approved transaction. If the payment transaction is declined, the reader mode device displays notification of a declined transaction, and requests new payment account information to complete the payment transaction.

These and other aspects, objects, features, and advantages of the exemplary embodiments will become apparent to those having ordinary skill in the art upon consideration of the following detailed description of illustrated exemplary embodiments.

### BRIEF DESCRIPTION OF THE DRAWINGS

FIG. 1 is a block diagram depicting a system for processing payment transactions, in accordance with certain example embodiments.

FIG. 2 is a block diagram depicting a method for processing payment transactions, in accordance with certain example embodiments.

FIG. 3 is a block diagram depicting a method for configuring a reader mode device in a reader communication mode, in accordance with certain example embodiments.

FIG. 4 is a block diagram depicting a method for establishing a secure communication channel between a reader mode device and a payment device, in accordance with certain example embodiments.

FIG. 5 is a block diagram depicting a method for receiving payment account information from the payment device, in accordance with certain example embodiments.

FIG. 6 is a block diagram depicting a method for processing a payment transaction by a payment processing system, in accordance with certain example embodiments.

FIG. 7 is a block diagram depicting a method for verifying payment account information in accordance with certain example embodiments.

FIG. 8 is a block diagram depicting a computing machine and module, in accordance with certain example embodiments.

### DETAILED DESCRIPTION OF THE EXAMPLE EMBODIMENTS

### Overview

The example embodiments described herein provide computer-implemented techniques for completing a payment transaction using a wireless reader mode device and a wireless communication-enabled payment device with a secure memory. The wireless reader mode device (for example, a mobile phone) is enabled as a radio frequency (RF) enabled payment device reader (for example, a smart card reader) that can facilitate payment transactions. In an example embodiment, the reader mode device and the payment device communicate via a near field communication (NFC) communication channel. In another example embodiment, the devices communicate via a Bluetooth, Wi-Fi, or other wireless communication channel. The reader mode device is configured as a wireless point of sale (POS) terminal to facilitate the payment transaction with the payment device. In an example embodiment, the wireless POS terminal can be used to facilitate a payment transaction with any wireless payment device (for example, smart cards, tags, fobs, mobile phones, and other wireless devices capable of storing payment account information).

The user selects an application on the reader mode device. For example, a merchant opens an application on a mobile device that allows the merchant to accept credit card payments via the reader mode device. The user interacts with the application on the reader mode device. Continuing with the previous example, the user is a merchant or a merchant's authorized agent completing a sale by processing a payment transaction. In another example, the user is a customer and the customer interacts with the application by selecting items to purchase from a merchant. In another example, the user is a customer, merchant, or other user, and interacts with the application by entering a payment amount due to complete a transaction with the application.

The user requests that the application initiate a payment transaction with the payment device. For example, the user of the payment device desires to make a payment using a card that comprises an NFC-enabled tag or an NFC-enabled chip (for example, a secure memory or a secure element). The application activates an NFC-reader mode on the reader mode device. In an example embodiment, the reader mode device is a mobile device that is connected to a cellular network or other wide-area wireless network. In an example embodiment, the reader mode device has an algorithm or service for activating the NFC-reader mode that is initiated by the application. For example, the reader mode device is configured to allow specified applications to initiate the algorithm or service to engage the NFC-reader mode on the reader mode device. In another example embodiment, the application transmits an original request to the reader mode device to activate the NFC-reader mode. The application disables conflicting modes on the reader mode device. For example, automatic identification beaming is a conflicting mode configured on the reader mode device to share information with other reader mode devices in proximity. In an example embodiment, automatic identification information beaming uses specific RF tag functionality (such as, “Type 4 Tags), which can interfere with requesting, receiving and/or processing payment account information. In this embodiment, automatic identification beaming functionality is disabled when the reader mode device is configured to NFC-reader mode to enable the reading of payment account information.

The reader mode device activates a secure communication channel via an antenna. In an example embodiment, the reader mode device communicates with an NFC controller to activate an RF field. When the payment device is moved into a predefined proximity of the reader mode device (for example, when the user “taps” the NFC-enable tag of the card in the RF field of the reader mode device), the reader mode device detects the payment device and an application on the payment device is activated. For example, the payment device is a mobile device that is detected through a polling request and a response. In another example, the payment device is a smart card and an application on the NFC-enabled tag is activated by detecting the proximity of the tag to the RF field. The payment device accepts a secure communication channel request from the reader mode device and allows the secure communication channel to be established. In an example embodiment, the application on the payment device only accepts secure communication channel requests from a requesting application on a reader mode device having a certificate from the financial institution associated with the payment device.

If there is a secure element on the payment device, the application on the secure element of the payment device transmits a payment account information request to the payment device. In an example embodiment, a secure memory application of the reader mode device transmits the payment request to the payment device. In this embodiment, the secure memory of the reader mode device comprises an applet or application with a certificate granted by a financial institution that allows the secure memory of the reader mode device to access secure payment account information from the payment device. In an example embodiment, the payment account information request is a request for payment account information, which comprises financial account information (for example, credit account, debit account, stored value account, gift account, loyalty account, or other forms of financial account information). In another example embodiment, the payment account information comprises secure information contained in a secure memory or secure element of the payment device that conforms to a standardized protocol (such as a Europay, MasterCard, and VISA (EMV) protocol). In an example embodiment, the payment account information stored in the secure memory of the payment device is not understood by the reader mode device. In another example embodiment, a financial institution corresponding to the payment account information enables the secure memory of the reader mode device to access one or more cryptographic keys that enable the reader mode device to receive and interpret the secure payment account information.

The payment device receives the payment account information request. In an example embodiment, the application on a secure element of the payment device receives a request to retrieve the payment account information. For example, the secure memory application of the payment device receives a command compatible with the EMV protocol directing it to reveal the secure payment account information. The payment device retrieves and transmits payment account information to the reader mode device. The application on the secure element of the payment device receives the payment account information. Continuing with a previous example in which a financial institution grants a certificate to allow the secure memory of the reader mode device to request and receive secure financial information, the application on the reader mode device is not capable of accessing financial information received by the secure memory application.

If there is no secure element on the payment device, the application on the reader mode device transmits the payment account information request to the payment device. The payment device transmits payment account information to the reader mode device. In an example embodiment, payment account information received by the application on the reader mode device is unencrypted. In an example embodiment, the application on the reader mode device cannot request or receive financial information from the payment device if there is also a secure memory application on the reader mode device.

In an example embodiment, the reader mode device verifies the payment account information received from the payment device. In another example embodiment, the payment device is a reader mode device and the payment device verifies the payment account information. The reader mode device displays a verification request. In an example embodiment, the application on the reader mode device transmits the verification request. The user enters verification information that corresponds to the payment account information (for example, a pin number, card verification number, or other form of verification associated with the payment device and/or the payment account information). In another example embodiment, the payment device comprises a user interface and verification information is received and processed by the payment device.

If there is a secure element on the reader mode device, the application on the secure element of the reader mode device receives the verification information with which it verifies the payment account information. If there is no secure element on the reader mode device, the application on the reader mode device receives the verification information with which it verifies the payment account information. In another example embodiment, the reader mode device connects to a third party system to verify the payment account information. In an example embodiment, the user places the payment device or another device in the proximity of the reader mode device so that the application on the reader mode device (or the application on the secure element of the reader mode device) can request and/or receive the verification information. For example, the reader mode device scans a code (for example, a barcode or QR code), reads a magnetic stripe, or reads an RF-enabled tag or chip that is associated with the payment account information transmitted by the payment device. In an example embodiment, the reader mode device communicates with the payment processing system in order to verify payment account information. For example, the user enters a PIN number, which the reader mode device relays to the payment processing system, which has a database to cross reference PIN numbers with payment account information. If the payment account information is not verified, the reader mode device displays an error message. If the payment account information is verified, the reader mode device encrypts the payment account information.

If there is a secure element on the reader mode device, the application on the secure element of the reader mode device encrypts the payment account information and transmits it to the application on the reader mode device. The application on the reader mode device transmits the encrypted payment account information to a payment processing system. In an example embodiment, the application on the reader mode device can only receive encrypted financial information from the application on the secure element of the reader mode device. In the same embodiment, the application on the reader mode device does not have access to the cryptographic key necessary to decrypt financial information received from the application on the secure element of the reader mode device. For example, the application on the reader mode device passively channels financial account information from the secure memory application to the payment processing system without accessing the information.

If there is no secure element on the reader mode device, the application on the reader mode device encrypts the payment account information and transmits it to the payment processing system. In another example embodiment, the payment account information is received from the payment device in an encrypted format and is transmitted to the payment processing system without re-encryption.

The payment account information is received by the payment processing system. The payment processing system decrypts the payment account information and processes the payment transaction. If the payment transaction is approved by the payment processing system, the reader mode device displays notification of the approved transaction. For example, the user interface of the reader mode device may display a pop-up window that notifies the user that the transaction was successful. If the transaction is declined, the reader mode device displays a notification of a declined transaction and a request to provide new payment account information. In an example embodiment, the user interface of the reader mode device displays an option to re-scan the payment device or cancel the transaction.

The inventive functionality of the invention will be explained in more detail in the following description, read in conjunction with the figures illustrating the program flow.

### Example System Architecture

Turning now to the drawings, in which like numerals indicate like (but not necessarily identical) elements throughout the figures, example embodiments are described in detail.

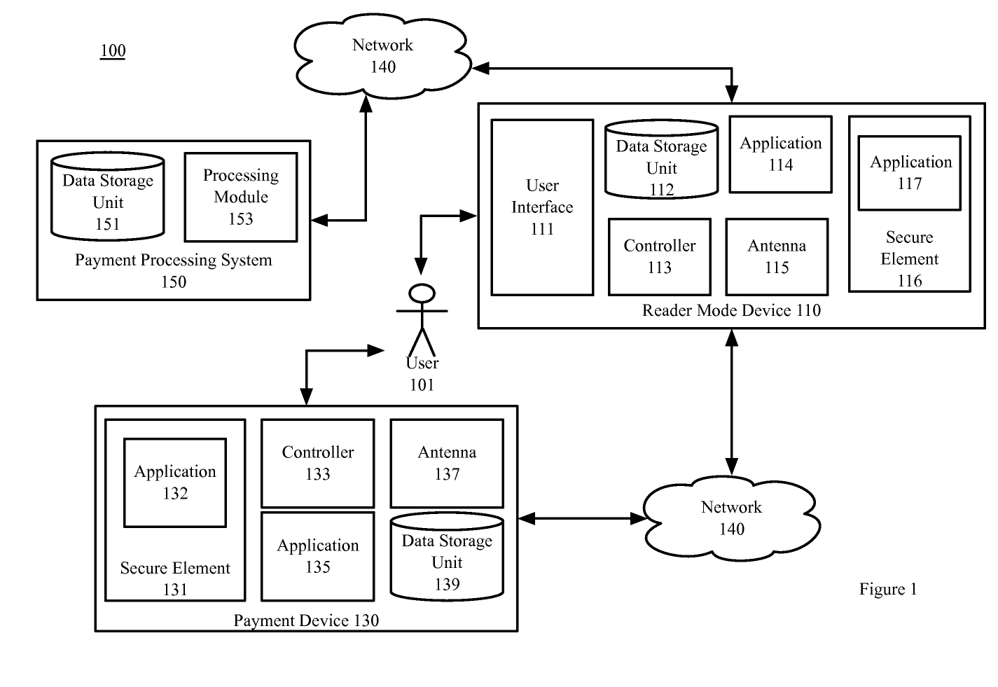

FIG. 1 is a block diagram depicting a system for processing payment transactions, in accordance with certain example embodiments. As depicted in FIG. 1, the exemplary operating environment 100 comprises a reader mode device 110 configured to communicate over a network 140 with a payment device 130 and a payment processing system 150. In some embodiments, a user 101 associated with the reader mode device 110 and/or payment device 130 must install an application (114 and 135) and/or make a feature selection to obtain the benefits of the techniques described herein.

Each network 140 includes a wired or wireless telecommunication means by which network system or device (including 110, 130, and 150) can communicate and exchange data. For example, each network 140 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, Bluetooth, near field communication network (NFC), any form of standardized radio frequency, or any combination thereof, or any other appropriate architecture or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

Each network system or device (including 110, 130 and 150) includes a communication module capable of transmitting and receiving data over the network 140. For example, each network system or device (including 110, 130, and 150) can comprise a server, personal computer, mobile device (for example, notebook computer, tablet computer, netbook computer, personal digital assistant (PDA), video game device, GPS locator device, cellular telephone, Smartphone, or other mobile device), a television with one or more processors embedded therein and/or coupled thereto, or other appropriate technology that includes or is coupled to a web browser or other application for communicating via the network 140. In the example embodiment depicted in FIG. 1, the network systems and devices (including 110, 130, and 150) are operated by a reader mode device user 101, a payment device user 101, and a payment processing system operator, respectively.

An example reader mode device 110 comprises a user interface 111, a data storage unit 112, a controller 113, an application 114 and/or 117, an antenna 115, and a secure element 116. In an example embodiment, the user interface 111 enables the user 101 to interact with the application 114 on the reader mode device 110. For example, the user interface 111 may be a touch screen, a web page, a voice based interface, or any other interface, which allows the user 101 to provide input and receive output from the application 114. In an example embodiment, the user interface 111 enables the user 101 to request that the application 114 initiate a payment transaction and communicate with the payment device 130. In another example embodiment, the user interface 111 enables the user 101 to select whether to provide new payment account information or to cancel a transaction after notification is received by the reader mode device 110 of the declined payment transaction. In another example embodiment, the user interface 111 displays an error message to the user 101 when the reader mode device 110 is unable to verify payment account information, displays a notice of approved transaction after the payment processing system 150 successfully processes the payment transaction, transmits notice of approved transaction to the reader mode device 110, and displays cancelled transaction results after the user 101 selects to cancel a declined transaction.

In an example embodiment, the data storage unit 112 can include any local or remote data storage structure accessible to the reader mode device 110 suitable for storing information. In an example embodiment, the data storage unit 112 stores encrypted information, such as HTML5 local storage. In an example embodiment, the data storage unit 112 stores payment account information received from the payment device 130 for later retrieval. In an example embodiment, the data storage unit 112 stores verification information received from a payment device 130, from a user 101, or from another device proffered by the user 101 to transmit verification information. In another example embodiment, the data storage unit 112 is a part of or component of the secure element 116.

In an example embodiment, the application 114 is a program, function, routine, applet, or similar entity that exists on and performs its operations on the reader mode device 110. In some embodiments, the user 101 must install the application 114 and/or make a feature selection on the reader mode device 110 to obtain the benefits of the techniques described herein. In an example embodiment, the user 101 may access the application 114 on the reader mode device 110 via the user interface 111. In an example embodiment, the application 114 can transmit a request to a controller 113 to deactivate conflicting communication modes on the reader mode device 110 that may interfere with establishing a secure communication channel with, sending information to, or receiving information from the payment device 130. In an example embodiment, this request is transmitted automatically when the application 114 is accessed by the user 101. In an example embodiment, the application 114 may request the controller 113 to activate the secure communication channel via an antenna 115. In an example embodiment, the application 114 may request payment account information or verification information from the payment device 130. In an example embodiment, the application 114 on the reader mode device 110 cannot request or receive financial information from the payment device 130 if there is also a secure element 116 application 117 on the reader mode device 110. In an example embodiment, the application 114 can encrypt payment account information received from the payment device 130. In another example embodiment, the application 114 can transmit to the payment processing system 150 (but not decrypt) encrypted payment account information received from the secure element 116 application 117 on the reader mode device 110. In another example embodiment, the application 114 is a part of or component of the secure element 116.

An example reader mode device 110 comprises a secure element 116, secure memory, or secure sub-device, which can exist within a removable smart chip or a secure digital (SD) card or which can be embedded within a fixed chip on the reader mode device 110. In certain example embodiments, Subscriber Identity Module (SIM) cards may be capable of hosting a secure element 116, for example, an NFC SIM Card. The secure element 116 allows a software application 117 resident on the reader mode device 110 and accessible by the device user 101 to interact securely with certain functions within the secure element 116, while protecting information stored within the secure element 116. In an example embodiment, the secure element 116 comprises applications 117 running thereon that perform the functionality described herein. In an example embodiment, the secure element 116 comprises components typical of a smart card, such as crypto processors and random generators. In an example embodiment, the secure element 116 comprises a Smart MX type NFC controller in a highly secure system on a chip controlled by a smart card operating system, such as a JavaCard Open Platform (JCOP) operating system. In another example embodiment, the secure element 116 is configured to include a non-EMV type contactless smart card, as an optional implementation. The secure element 116 communicates with the application 117 in the reader mode device 110. In an example embodiment, the secure element 116 is capable of storing encrypted user information and only allowing trusted applications to access the stored information. In an example embodiment, a controller 113 interacts with a secure key encrypted application 117 for decryption and installation in the secure element 116.

In an example embodiment, the application 117 on the secure element 116 on the reader mode device 110 requests and receives payment account information from the payment device 130, to the exclusion of application 114. In this example embodiment, the application 117 can encrypt and transmits payment information via the application 114 to the payment processing system 150 in a format that application 114 cannot decrypt. In another example embodiment, the application 117 is capable of transmitting payment information directly to the payment processing system via the network 140. Additionally, the secure element 116 also may comprise secure software applications 117, such as payment applications, secure forms of the applications 114, authentication applications, payment provisioning applications, or other suitable application using the secure functionality of the secure element 116.

In an example embodiment, the data storage unit 112 and application 114 may be implemented in the secure element 116, as described previously, on the reader mode device 110.

In an example embodiment, the controller 113 communicates with the application 114 (or application 117 within the secure element 116) and is capable of sending and receiving data over the wireless communication channel. In an example embodiment, the controller 113 activates the antenna 115 to create the secure communication channel. In an example embodiment, the controller 113 is an NFC controller, Wi-Fi controller, or Bluetooth link controller.

The reader mode device 110 communicates with the payment device 130 via the antenna 115. When the reader mode device 110 has been activated and prioritized, the controller 113 is notified of the state of readiness of the reader mode device 110 for a transaction. The controller 113 polls through the antenna 115 a radio signal, or listens for radio signals from the payment device 130.

In an example embodiment, the reader mode device 110 communicates with the payment device 130 via a network 140. In an example embodiment, the network comprises a proximity communication connection by which network devices (including 110 and 130) can exchange data, such as NFC, Wi-Fi, or Bluetooth. Throughout this specification, it should be understood that the terms “data” and “information” are used interchangeably herein to refer to text, images, audio, video, or any other form of information that can exist in a computer-based environment.

In an example embodiment, the payment device 130 comprises a secure element 131, a controller 133, an application 132 and/or 135, an antenna 137, and a data storage unit 139. In an example embodiment, the secure element 131, secure sub-device, or secure memory can exist within a removable smart chip or a secure digital (SD) card, or can be imbedded within a fixed chip on the payment device 130. In an example embodiment, Subscribed Identity Module (SIM) cards may be capable of hosting a secure element 131, for example, an NFC SIM Card. In an example embodiment, payment account information and other information compliant with Europay, Visa, and MasterCard (EMV) protocols is stored within the secure element 131. In an example embodiment the application 132 is a program, function, routine, applet, or similar entity that exists on and performs its operations within the secure element 131 on a payment device 130. In an example embodiment, the application 132 can communicate with the controller 133 in order to send payment account information over the network 140 via the antenna 137. In another example embodiment, the application 132 does not exist within the secure element 131. In this embodiment, the application 135 can communicate with the controller 133 in order to send payment account information over the network 140.

In an example embodiment, the data storage unit 139 comprises any local or remote data storage structure accessible to the payment device 130 suitable for storing information. In an example embodiment, the data storage unit 139 stores encrypted information, such as HTML5 local storage. In an example embodiment, the data storage unit 139 stores payment account information. In an example embodiment, the data storage unit 139 and application 135 may be implemented in the secure element 131, as described previously, on the payment device 130.

In an example embodiment, the controller 133 communicates with the application 135 (or application 132 within the secure element 131) and is capable of sending and receiving data over the wireless communication channel. In an example embodiment, the controller 133 activates the antenna 137 to establish the secure communication channel. In an example embodiment, the controller 133 is an NFC controller, Wi-Fi controller, or Bluetooth link controller. In an example embodiment, the payment device 130 communicates with the reader mode device 110 via the antenna 137.

In an example embodiment, the reader mode device 110 communicates with the payment processing system 150 via the network 140. In an example embodiment, the payment processing system 150 comprises a data storage unit 151 and a processing module 153. In an example embodiment, the data storage unit 151 comprises any local or remote data storage structure accessible to the payment processing system 150 suitable for storing information. In an example embodiment, the processing module 153 can be utilized by the payment processing system 150 to process payment transactions using payment account information received from the reader mode device 110.

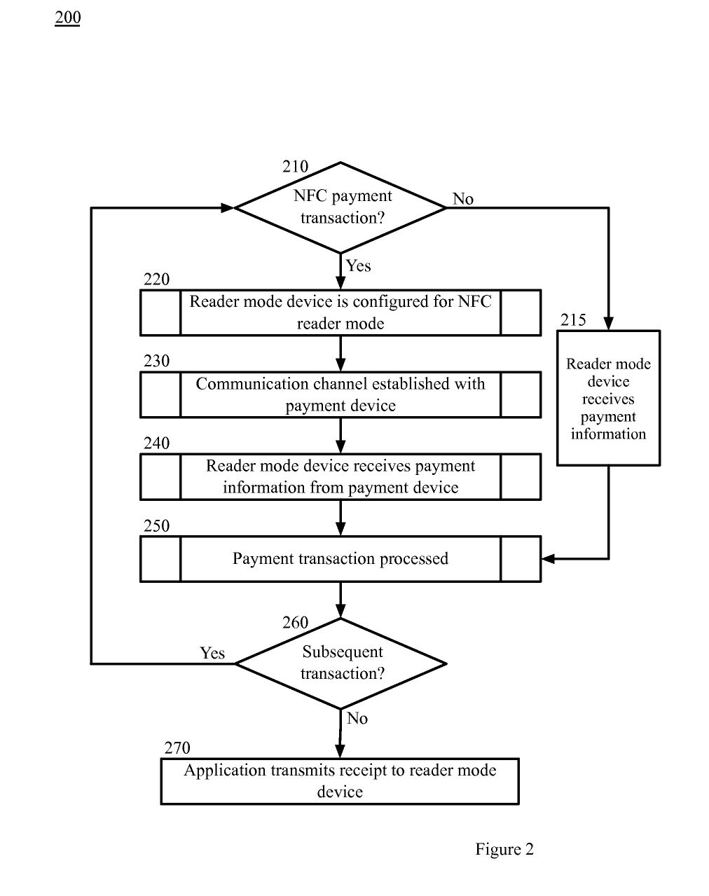

The components of the example-operating environment 100 are described hereinafter with reference to the example methods illustrated in FIGS. 2-6. The example methods of FIGS. 2-6 may also be performed with other systems and in other environments.

### Example System Process

FIG. 2 is a block flow diagram depicting a method 200 for processing payment transactions. The method 200 is described with reference to the components illustrated in FIG. 1. In an example embodiment, the devices communicate using an RF wireless communication technology, such as NFC. In other example embodiments, the devices communicate using other RF wireless communication technologies, such as Bluetooth or Wi-Fi. In an example embodiment, the reader mode device 110 is a mobile telephone or other mobile device that typically communicates with other devices and other systems via a wide area or cellular network 140. In this embodiment, the reader mode device 110 is also capable of being configured to communicate with other devices via an RF wireless communication technology.

In block 210, the reader mode device 110 determines whether the payment transaction is an NFC payment transaction. In an example embodiment, the reader mode device 110 receives a command or input from a user 101 indicating a desire to process a payment transaction and/or initiate a NFC payment transaction. In an example embodiment, the user 101 accesses an application 114 on the reader mode device 110 and initiates the transaction. In another example embodiment, the payment device 130 is placed in the proximity of the reader mode device 110 and an application 114 is initiated on the reader mode device 110. In another example embodiment, the reader mode device 110 has completed a first payment transaction with the payment device 130 and the user 101 desires to initiate a second payment transaction.

If the payment transaction is not a NFC payment transaction, the method 200 proceeds to block 215. In block 215, the reader mode device 110 receives payment account information. In an example embodiment, the user 101 swipes a magnetic stripe of the payment device 130 in order to transmit the payment account information to the reader mode device 110. In another example embodiment, the user 101 scans a barcode or other payment code of the payment device 130. In another example embodiment, the user 101 enters the payment account information into the reader mode device 110 or otherwise permits access to the payment account information on the reader mode device 110 (for example, by permitting access to a digital wallet account or other account that stores the financial payment account information).

From block 215, the method 200 proceeds to block 250.

Returning to block 210, if the payment transaction is a NFC payment transaction, the method 200 proceeds to block 220.

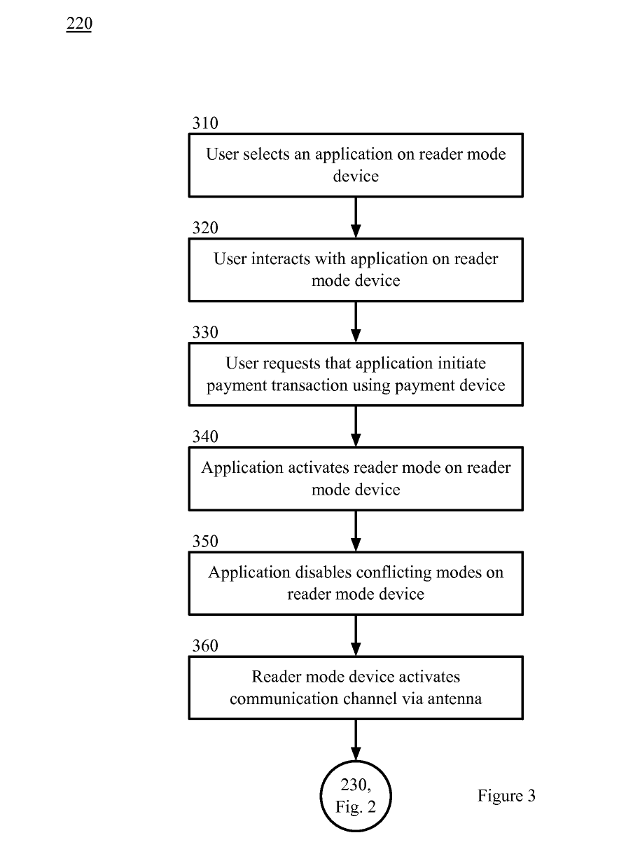

In block 220, the reader mode device 110 is configured for NFC reader mode. In an example embodiment, the reader mode device 110 typically communicates with other devices and other systems via a wide area or cellular network 140, but is capable of being configured to communicate via a NFC wireless communication channel. In an example embodiment, the reader mode device 110 is configured to an RF wireless communication technology “reader” mode to allow it to read and/or receive payment account information from other devices, such as a payment device 130, to process payment transactions. The method for configuring the reader mode device 110 for reader mode is described in more detail hereinafter with reference to the methods described in FIG. 3.

FIG. 3 is a block flow diagram depicting a method 220 for configuring a reader mode device 110 in a reader communication mode, in accordance with certain example embodiments, as referenced in block 220. The method 220 is described with reference to the components illustrated in FIG. 1.

In block 310, the user 101 selects an application 114 on the reader mode device 110. In an example embodiment, the user 101 selects the application 114 via the user interface 111 and opens the application 114. In another example embodiment, the reader mode device 110 detects the presence of the payment device 130 and automatically opens an application 114 to enable communication with the payment device 130.

In block 320, the user 101 interacts with the application 114 on the reader mode device 110. In an example embodiment, the user 101 is a merchant. In this embodiment, a customer has selected items for purchase, and the merchant uses the application 114 to calculate the transaction total for the items selected for purchase. In another example embodiment, the user 101 is a customer and the customer interacts with the application 114 by selecting items to purchase from a merchant. In another example, the user 101 is a customer, merchant, or other user, who interacts with the application 114 by entering a payment amount due to complete a transaction (for example, to receive a transfer of funds from another user 101).

In block 330, the user 101 requests that the application 114 initiate a payment transaction using the payment device 130. In another example embodiment, the user 101 selects to initiate a payment transaction and the reader mode device 110 interprets the selection as initiating a payment transaction with an NFC-enabled payment device 130. For example, a merchant, accessing the virtual shopping cart via the application 114, selects “check out” to initiate a payment transaction. In an example embodiment, the user 101 selects to initiate a payment transaction with an NFC-enabled payment device 130. For example, a merchant accessing the virtual shopping cart via t the application 114, selects “pay now using NFC-enabled credit card” to initiate a payment transaction. In another example embodiment, the reader mode device 110 detects the payment device 130 and initiates the payment transaction.

In block 340, the application 114 activates reader mode on the reader mode device 110. In an example embodiment, reader mode comprises configuring the reader mode device 110 to be able to request, read, and/or receive payment account information from the payment device 110. In an example embodiment, the application 114 activates reader mode upon the user 101 selecting the application 114 on the reader mode device 110. In another example embodiment, the application 114 actives the reader mode upon receipt of the request to initiate the payment transaction. In yet another example embodiment, the application 114 activates the reader mode upon detection of the payment device 130. In another example embodiment, the user 101 activates a setting or command on the reader mode device 110 to active the reader mode.

In block 350, the application 114 disables conflicting modes on the reader mode device 110. In an example embodiment, the reader mode device 110 is configured to share information with other devices when a NFC wireless communication channel is established. In this embodiment, the reader mode device 110 is able to receive and transmit information to the other reader mode device. However, in order to securely receive payment account information to process the payment transaction, this communication mode must be disabled to enable a “reader-only” communication mode. For example, automatic identification beaming may be configured on the reader mode device 110 to share information with other reader mode devices in NFC proximity. This automatic identification beaming interferes with retrieving payment account information via the NFC wireless communication channel. Therefore, the automatic identification beaming functionality must be disabled when the reader mode device 110 is configured to read payment account information via the NFC wireless communication channel. In example embodiment, the application 114 disables conflicting modes on the reader mode device 110 in response to the activation of the reader mode.

In block 360, the reader mode device 110 activates the wireless communication channel via the antenna 115. In an example embodiment, the application 114 communicates with the controller 113 and activates the antenna 115 to generate an RF field. The RF field comprises a proximity communication channel, such as a NFC wireless communication channel. For example, the application 114 communicates with an NFC controller 113 in order to activate an NFC antenna 115. The NFC antenna propagates the NFC communication channel to enable secure communication with the NFC-enabled payment device 130.

The method 220 then proceeds to block 230 in FIG. 2.

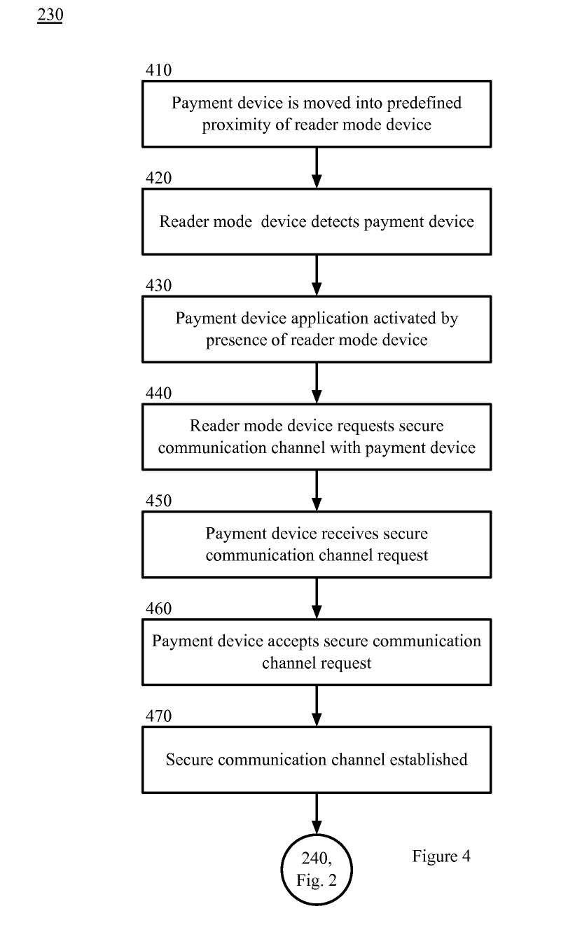

Returning to FIG. 2, in block 230, the wireless communication channel is established with the payment device 130. In an example embodiment, the wireless communication channel enables the secure transfer of payment account information to complete the payment transaction. In an example embodiment, the wireless communication channel is a NFC communication channel. The method for establishing the wireless communication channel with the payment device 130 is described in more detail hereinafter with reference to the methods described in FIG. 4.

FIG. 4 is a block flow diagram depicting a method 230 for establishing a network 140 between a reader mode device 110 and a payment device 130, in accordance with certain example embodiments, as referenced in block 230. The method 230 is described with reference to the components illustrated in FIG. 1.

In block 410, the payment device 130 is moved into a certain or predefined proximity of the reader mode device 110. In an example embodiment, the required proximity distance between the devices (including devices 110 and 130) is defined by the type of RF wireless communication channel established. For example, NFC communication distances generally range from about 3 to about 4 inches. In an example embodiment, the user 101 “taps” the NFC-enable payment device in the RF field of the reader mode device 110 by moving the payment device 130 within the predefined proximity of the reader mode device 110. In an example embodiment, the predefined proximity is based at least in part on the strength of the generated RF field and/or the type of wireless communication used by the devices (including devices 110 and 130).

In block 420, the reader mode device 110 detects the payment device 130. In an example embodiment, the reader mode device 110 detects when the payment device 130 is moved into the RF field and/or moved within the predefined proximity of the reader mode device 110. In another example embodiment, the payment device 130 detects the reader mode device 110. In an example embodiment, the detection of the physical proximity of the payment device 130 ensures that the reader mode device 110 is communicating with only one payment device 130. In another example embodiment, the detection of the physical proximity of the payment device 130 ensures that the payment device 130 is physically present within the RF field generated by the reader mode device 110.

In block 430, the payment device application 135 is activated. In an example embodiment, the payment device application 135 is activated when the payment device 130 detects the RF field generated by the antenna 115 of the reader mode device 110. In an example embodiment, an NFC-enabled tag or component of the payment device 130 is activated and/or energized by the RF field generated by the reader mode device 110.

In block 440, the reader mode device 110 requests a secure communication channel with the payment device 130. In an example embodiment, the reader mode device 110 application 114 and the payment device application 135 establish any number of protocols to enable a secure communication, including but not limited to NFC protocols, Bluetooth protocols, or Wi-Fi protocols. In an example embodiment, the reader mode device 110 and the payment device 130 exchange a key to set up a secure communication channel. In an example embodiment, a Wi-Fi secure network 140 can comprise secure communication functionality, such as cryptographic protocols, including transport layer security or secure socket layer protocols, or other secure communication methodology. In another example embodiment, a Bluetooth secure communication channel can comprise Bluetooth protocols such as a link management protocol (LMP), logical link control and adaptation protocol (L2CAP), and service discovery protocol (SDP). In an example embodiment, Bluetooth pairing of the reader mode device 110 and the payment device 130 can occur automatically by such communication. In yet another example embodiment, the reader mode device 110 may display a request to authorize pairing with the payment device 130 to enable a secure Bluetooth communication.

In block 450, payment device 130 receives the secure communication channel request. In another example embodiment, the reader mode device 110 receives the communication channel network request from the payment device 130.

In block 460, the payment device 130 accepts the secure communication channel request. In another example embodiment, the reader mode device 110 accepts the secure communication channel request. In an example embodiment, during this process, the payment device 130 and the reader mode device 110 establish a secure communication relationship by creating an encryption key for use in encrypting communications between the devices (including devices 110 and 130). In an example embodiment, the payment device 130 does not accept the secure communication channel request from reader mode devices 110 if the reader mode device 110 does not have a required certificate within its secure element 116. For example, a payment device 130 only accepts secure communication channel requests from a requesting application 117 on a reader mode device that has a certificate from the financial institution associated with the payment device 130. In another example embodiment, the payment device 130 determines whether to accept the secure communication channel request by determining whether the reader mode device 110 and/or the application 117 or 114 has access to proper public keys or tokens. In yet another example embodiment, the reader mode device 110 makes this determination.

In block 470, the secure communication channel is established. For example, the NFC-enabled payment device 130 and the reader mode device 110 successfully establish a secure communication channel according to an NFC protocol, after having detected each other and exchanged a cryptographic key.

The method 230 then proceeds to block 240 in FIG. 2.

Returning to FIG. 2, in block 240, the reader mode device 110 receives the payment account information from the payment device 130. In an example embodiment, the payment account information comprises financial account information. In an example embodiment, the payment account information comprises financial account information and account verification information. In an example embodiment, the financial account information comprises information for a credit account, debit account, stored value account, gift account, loyalty account, or other forms of financial account information. In another example embodiment, the payment account information comprises secure information contained in a secure memory, secure element 131, or secure sub-device of the payment device 110 that conforms to a standardized protocol (such as a Europay, MasterCard, and VISA (EMV) protocol).

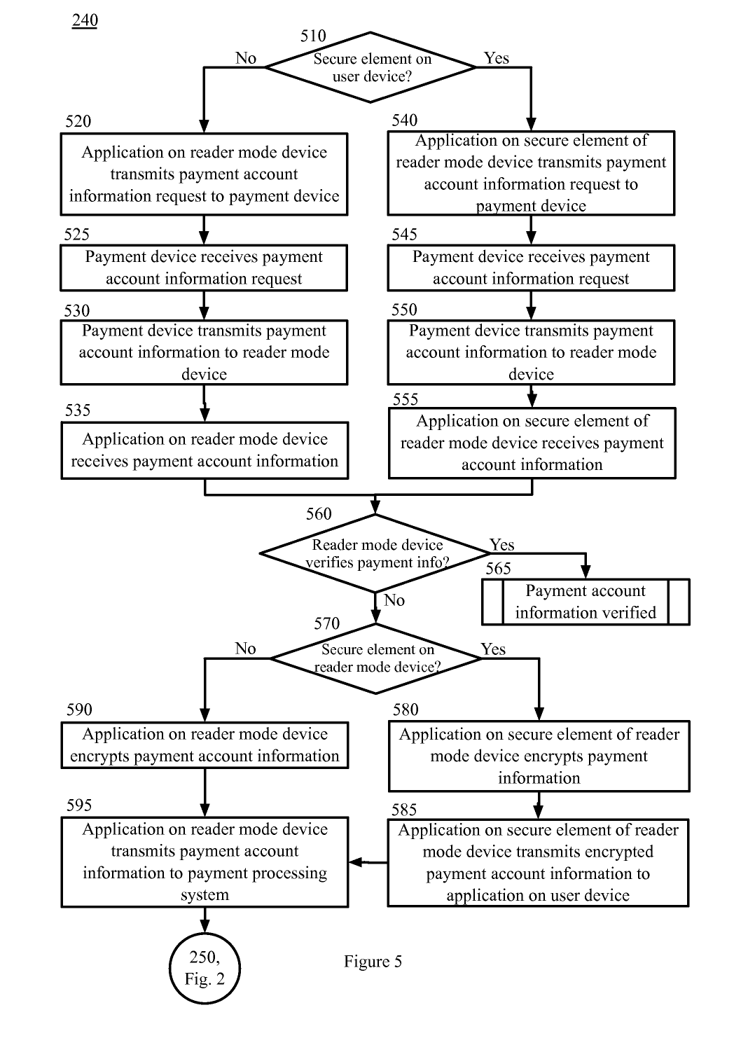

In an example embodiment, the payment account information stored in the secure element 131 of the payment device 130 is not readable or capable of being understood by the application 114 on the reader mode device 110. In another example embodiment, a financial institution corresponding to the payment account information provides the reader mode device 110 secure element 116 access to one or more cryptographic keys that enable the reader mode device 110 to receive and interpret the secure payment account information. In an example embodiment, the payment verification information may be present on the payment device 130 secure element 131 and is transmitted with the financial account information. In another example embodiment, the payment verification information is not transmitted with the financial account information and must be separately requested by the reader mode device 110. The method 240 for receiving payment account information from the payment device 110 is described in more detail hereinafter with reference to the methods described in FIG. 5.

FIG. 5 is a block flow diagram depicting a method 240 for receiving payment account information from the payment device 130, in accordance with certain example embodiments, as referenced in block 240. The method 240 is described with reference to the components illustrated in FIG. 1.

In block 510, the reader mode device 110 determines whether a secure element 116 is present on the reader mode device 110. In an example embodiment, communication of payment account information requests and receipt of payment account information occurs between the application 117 of the reader mode device 110 secure element 116 and the payment device 130. For example, a financial institution creates a payment device 130 that communicates certain financial account information when requested by a reader mode device 110 application 114 that is not located within a secure element 116, and communicates certain additional information when requested by a reader mode device 110 application 117 that is located within a secure element 116. In an example embodiment, the reader mode device 110 determines the location of the application (including 114 and 116) to determine whether the reader mode device 110 has a secure element 116.

If there is not a secure element 116, the method 240 proceeds to block 520. In block 520, the reader mode device 110 application 114 transmits a payment account information request to the payment device 130. In another example embodiment, the application 114 transmits a payment account information request comprising a request for payment account information and verification information from the payment device 130. In an example embodiment, the request comprises a request to read the payment account information from the payment device 130. In another example embodiment, the request comprises a request to transmit the payment account information to the reader mode device 110.

In block 525, the payment device receives the payment account information request. In an example embodiment, the payment device 130 application 135 receives the payment account information request. In another example embodiment, the application 132 within a secure element 131 of the payment device 130 receives the payment account information request. For example, an EMV chip within the payment device 130 receives the payment account information request.

In block 530, the payment device 130 transmits payment account information to the reader mode device 110. In an example embodiment, the payment account information is retrieved from the data storage unit 139. In another example embodiment, the payment account information is retrieved from the secure element 131. In an example embodiment, the payment information is transmitted in an unencrypted format. In another example embodiment, the secure element 131, the application 132 therein, or the application 135 encrypts the payment information prior to transmission to the reader mode device 110. In an example embodiment, the payment account information comprises financial account information. In another example embodiment, the payment account information comprises financial account information and verification information. In another example embodiment, the payment device 130 allows the reader mode device 110 to read the payment account information from the data storage unit 139, application 135, and/or secure element 131.

In block 535, the application 114 on the reader mode device 110 receives the payment account information. In an example embodiment, the application 114 receives the payment account information in an unencrypted format. In another example embodiment, the application 114 receives the payment information in an encrypted format.

The method 240 then proceeds to block 560.

Returning to block 510, if there is a secure element 116 on the reader mode device 110, the method 240 proceeds to block 540.

In block 540, the application 117 on the secure element 116 of the reader mode device 110 transmits the payment account information request to the payment device 130. In an example embodiment, the application 117 transmits a payment account information request comprising a request for payment account information and verification information from the payment device 130. In an example embodiment, the request comprises a request to read the payment account information from the payment device 130. In another example embodiment, the request comprises a request to transmit the payment account information to the reader mode device 110.

In block 545, the payment device 130 receives the payment account information request. In an example embodiment, the payment device 130 application 135 receives the payment account information request. In another example embodiment, the application 132 within a secure element 131 of the payment device 130 receives the payment account information request. For example, an EMV chip within the payment device 130 receives the payment account information request.

In block 550, the payment device 130 transmits payment account information to the reader mode device 110. In an example embodiment, the payment device 130 application 135 retrieves the payment account information from the data storage unit 139 and transmits the information to the reader mode device 110. In another example embodiment, the payment device 130 application 132 retrieves the payment account information from the secure element 131 storage and transmits the information to the reader mode device 110. In another example embodiment, the secure element 131, the application 132 therein, or the application 135 encrypts the payment information prior to transmission to the reader mode device 110 application 117. In an example embodiment, the payment account information comprises financial account information. In another example embodiment, the payment account information comprises financial account information and verification information. In another example embodiment, the payment device 130 allows the reader mode device 110 to read the payment account information from the data storage unit 139, application 135, and/or secure element 131.

In block 555, the application 117 on the secure element 116 of the reader mode device 110 receives the payment account information. In an example embodiment, the secure element 116 application 117 is the only component of the reader mode device 110 that can request and receive payment account information from the payment device 130. In the same example embodiment, the application 117 is the only component of the reader mode device 110 that can access or decrypt received payment account information from payment devices 130.

In block 560, the reader mode device 110 determines whether it will verify the payment account information. In an example embodiment, the reader mode device 110 requests the payment processing system 150 and/or the payment device 130 to notify whether payment account verification is necessary or should proceed. For example, a financial institution has a protective feature that when a payment device 130 is used out of country, the payment account information must be verified in a certain way in order to protect the user. Continuing with the same example, the reader mode device 110 notifies the payment processing system 150 that the payment device 130 is being used out of country and the payment processing system 150 notifies the reader mode device 110 that verification is necessary. In an example embodiment, the reader mode device 110 received the payment account verification information from the payment device 130. In another example embodiment, the reader mode device 110 must request the payment account verification information from the payment device 130 in order to complete verification. In yet another example embodiment, the payment verification information is not known or understood by the reader mode device 110. In this embodiment, the payment processing system 150 confirms the payment account verification information. In yet another example embodiment, the payment device 130 is a reader mode device 110. In this example embodiment, the payment device 130 verifies the payment account information (using the payment account verification information) before transmitting it to the reader mode device 110 with which the payment device 130 is transacting.

If the reader mode device 110 verifies the payment account information, the method 240 proceeds to block 565.

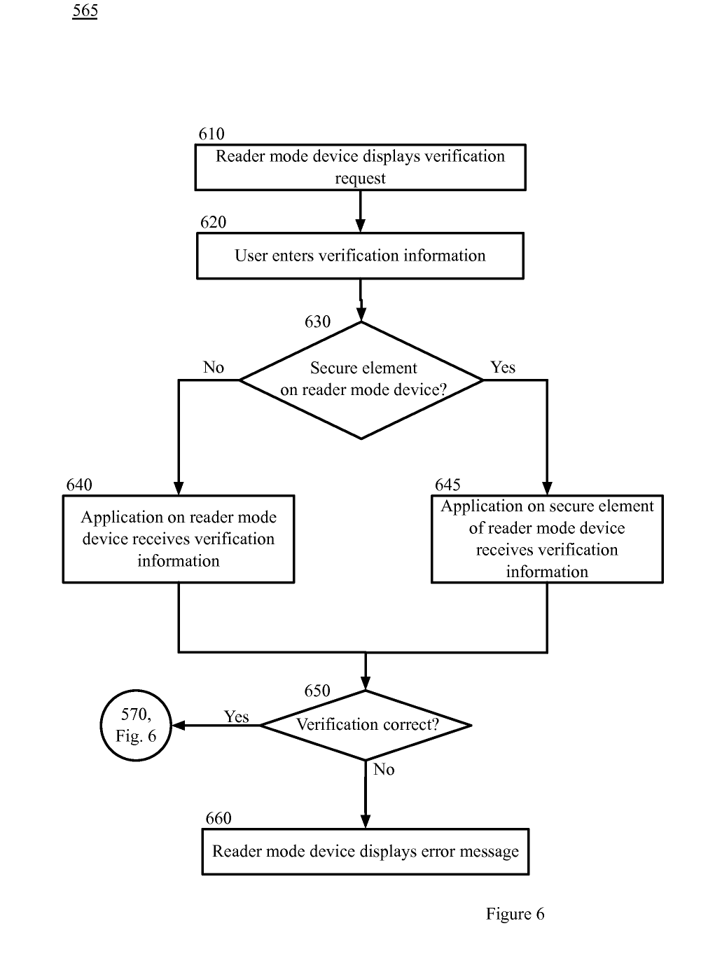

In block 565, the payment account information is verified. The method 565 for verifying payment account information is described in more detail hereinafter with reference to the methods described in FIG. 6.

FIG. 6 is a block flow diagram depicting a method 565 for verifying payment account information, in accordance with certain example embodiments, as referenced in block 565. The method 565 is described with reference to the components illustrated in FIG. 1.

In block 610, the reader mode device 110 displays a verification request. In an example embodiment, the verification request is displayed on the user interface 111. In an example embodiment, the reader mode device 110 is capable of reading and/or understanding at least part of the financial account information received from the payment device 130 and determines that a payment verification is required to process the payment transaction. In an example embodiment, the reader mode device 110 determines that a multi-step verification is required. For example, a personal identification number (PIN), card verification value or number (CVV), or other form of verification associated with the payment device 130 and/or the financial payment account and a photo identification of the user 101. In this embodiment, the reader mode device 110 displays a notice or request (for example, via a pop up window, alert, notification, or other display) requesting that the user enter or otherwise provide the verification information. In an example embodiment, the reader mode device 110 activates a scanner, camera, and/or a reader (for example, a bar code reader) so that the reader mode device 110 can receive the verification information from the payment device 130, an identification device, and/or another device containing the verification information.

In block 620, the user 101 enters or otherwise transmits the verification information. In an example embodiment, the user 101 enters his or her PIN, CVV, or other form of verification associated with the payment device 130 and/or the financial payment account. In another example embodiment, the user 101 provides verification information by placing the payment device 130 or another device in the proximity of the reader mode device 110, so that the reader mode device 110 can request and/or receive the verification information. For example, the reader mode device 110 scans a code (for example, a barcode or QR code), reads a magnetic stripe, or reads an RF-enabled tag or chip that is associated with the payment account information transmitted by the payment device 130. In yet another example embodiment, the verification information comprises a request to confirm the identity of the user 101 of the payment device 130 by reviewing a form of photo identification. For example, the merchant user 101 verifies that the customer using the payment device 130 is an authorized user of the payment device 130. In another example embodiment, the verification information request comprises a request to confirm the membership status or age of the user of the payment device 130. For example, a merchant is selling a restricted item and the information the customer provides enables the reader mode device 110 to verify that the customer is allowed to purchase the item (based on age, membership status with an organization, or other criteria).

In block 630, the reader mode device 110 determines whether there is a secure element 116 on the reader mode device 110. In an example embodiment, the application 117 of the reader mode device 110 secure element 116 and the payment device 130 receives verification information. In this embodiment, the application 117 is also the only component of the reader mode device 110 that can access the payment account information in order to facilitate payment verification.

If there is a secure element 116 on the reader mode device 110, the method 565 proceeds to block 645. In block 645, the application 117 on the secure element 116 of the reader mode device 110 receives the verification information. In an example embodiment, the application 117 receives the verification in formation in an encrypted format. In another example embodiment, the application 117 is unable to read or understand the verification information. In this embodiment, the reader mode device 110 transmits the verification information to the payment processing system 150 for verification.

From block 645, the method 565 proceeds to block 650.

Returning to block 630, if there is no secure element 116 on the reader mode device 110, the method 565 proceeds to block 640. In block 640, the application 114 on the reader mode device 110 receives the verification information. In an example embodiment, the application 114 receives the verification information in an encrypted format. In another example embodiment, the application 114 is unable to read or understand the verification information. In this embodiment, the reader mode device 110 transmits the verification information to the payment processing system 150 for verification.

In block 650, the reader mode device 110 determines whether the verification information is correct. In an example embodiment, the appropriate reader mode device 110 application (including 114 and 117) makes determines whether the verification information is correct. In an example embodiment, the reader mode device 110 compares the verification information received from the payment device 130 to the verification information received from the user 101. In another example embodiment, the reader mode device 110 requests the verification information from the payment device 130 and/or the payment processing system 150 and compares the verification information received from the user 101 to the verification information received from the payment device 130 and/or payment processing system 150. For example, the application (including 114 or 117) determines whether the PIN number, CVV number, or other verification received by the reader mode device 110 corresponds to the verification information provided by the payment device 130. In another example embodiment, the reader mode device 110 compares the verification information received from the payment device 130 to the verification information requested and received from the payment processing system 150. In another example embodiment, the reader mode device 110 compares the verification information received from the payment device 130 to the verification information received from a personal identification document or other device.

If the verification information is not correct, the method 565 proceeds to block 660. In block 660, the reader mode device 110 displays an error message. In an example embodiment, the reader mode device 110 displays a notice or message on the user interface 111 that the transaction cannot be processed because the payment account information was not verified. In an example embodiment, the reader mode device 110 prompts the user 101 to re-submit the verification information. In another example embodiment, the reader mode device 110 prompts the user 101 to submit other corroborating verification information that the user 101 has not submitted. For example, the reader mode device 110 communicates with the payment processing system 150 during the verification. In this embodiment, the payment processing system 150 notifies the reader mode device 110 that the payment transaction cannot be processed without the user 101 submitting another form of verification information. In another example embodiment, the reader mode device 110 prompts the user 101 to resubmit the payment account information.

Returning to block 650, if the verification information is correct, the method 565 proceeds to block 570 of FIG. 6.

Returning to block 560 in FIG. 6, if the reader mode device 110 does not verify the payment information, the method 240 proceeds to block 570.

In block 570, the reader mode device 110 determines whether there is a secure element 116 on the reader mode device 110.

If there is a secure element 116 on the reader mode device 110, the method 240 proceeds to block 580. In block 580, the application 117 on the secure element 116 of the reader mode device 110 encrypts the payment information. In an example embodiment, the secure element 116 application 117 is the only component of the reader mode device 110 that can access received payment account information from the payment device 130. In this example embodiment, the secure element 116 application 117 is the only component of the reader mode device 110 that can decrypt and/or encrypt received payment account information from payment devices 130. In an example embodiment, the reader mode device 110 secure element encrypts the payment account information so that it is only capable of being decrypted and understood by the payment processing system 150. In another example embodiment, the reader mode device 110 encrypts the payment account information via a secure sub-device on the reader mode device 110.

In block 585, the application 117 on the secure element 116 of the reader mode device 110 transmits the encrypted payment information to the application 114. In this example embodiment, the application 114 can receive encrypted payment information from the application 117 but cannot decrypt the payment information.

From block 585, the method 240 proceeds to block 595.

Returning to block 570, if there is no secure element 116 on the reader mode device 110, the method 240 proceeds to block 590. In block 590, the application 114 on the reader mode device 110 encrypts the payment account information.

In block 595, the application 114 on the reader mode device 110 transmits the payment account information to the payment processing system 150. In an example embodiment, the payment processing system 150 is a financial institution that maintains an account that corresponds to the payment account information transmitted by the payment device 130 (for example, the account issuer).

The method 240 then proceeds to block 250 in FIG. 2.

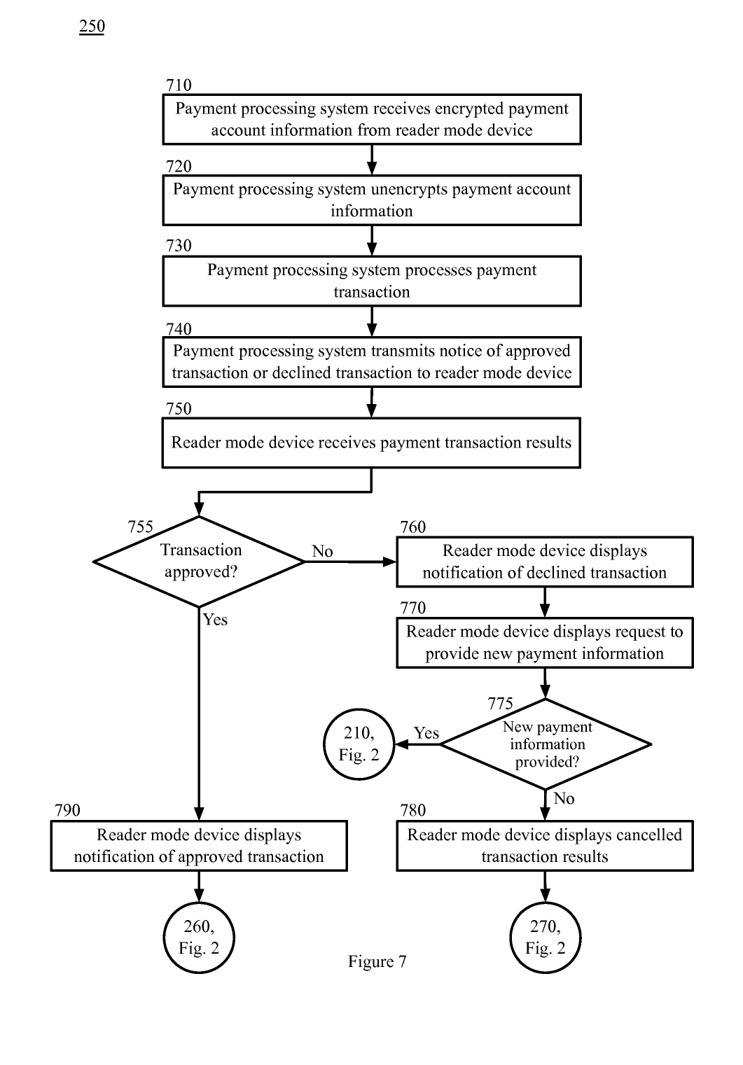

Returning to FIG. 2, in block 250, the payment transaction is processed. In an example embodiment, the payment transaction is processed by the payment processing system 150. The method 250 for processing a payment transaction is described in more detail hereinafter with reference to the methods described in FIG. 7.

FIG. 7 is a block flow diagram depicting a method 250 for processing a payment transaction by a payment processing system, in accordance with certain example embodiments, as referenced in block 250. The method 250 is described with reference to the components illustrated in FIG. 1.

In block 710, the payment processing system 150 receives the payment account information from the reader mode device 110. In an example embodiment, the payment processing system 150 receives unencrypted payment account information. In another example embodiment, the processing module 153 receives encrypted payment account information. In another example embodiment, the payment processing system 150 stores the payment account information in a data storage unit 151 for later retrieval by the processing module 153.

In block 720, the payment processing system 150 unencrypts the payment account information. In an example embodiment, the payment processing system 150 exchanges a cryptographic key with the appropriate application (114 or 117) on the reader mode device 110 when the reader mode device 110 transmits the payment account information so that the application (114 or 117) may encrypt the payment account information in such a way that the payment processing system 150 is able to decrypt it. In another example embodiment, the payment processing system 150 possesses a cryptographic key associated with information encrypted by the secure element 116 of the reader mode device 110 and/or information encrypted by the secure element 131 or secure sub-device of the payment device 130. For example, the payment processing system 150 possesses an algorithm or key to decrypt payment account information received from an EMV chip in the payment device 130.

In block 730, the payment processing system 150 processes the payment transaction. For example, the payment processing system 150 facilitates the movement of funds from a customer's account to a merchant's account. In an example embodiment, the payment processing system 150 determines whether the payment transaction is approved or declined for lack of sufficient funds.

In block 740, the payment processing system 150 transmits notice of approved transaction or declined transaction to the reader mode device 110.

In block 750, the reader mode device 110 receives the payment transaction results. For example, the reader mode device 110 receives notice that the transaction was approved or declined. In an example embodiment, the payment transaction results comprises one or more of the amount of the transaction, the time at which the transaction was effected, whether the transaction was approved or declined, and any other information relevant to the payment transaction.

In block 755, the reader mode device 110 reviews the payment transaction results and determines whether the transaction was approved or declined.

If the transaction was approved, the method 250 proceeds to block 790.

In block 790, the reader mode device 110 displays notification of the approved transaction. In an example embodiment, the reader mode device 110 displays the notification on the user interface 111. For example, the reader mode device 110 displays a pop-up window, notification, alert, or other message indicating that the transaction was approved.

The method 250 then proceeds to block 260 in FIG. 2.

Returning to block 755 in FIG. 7, if the transaction was declined, the method 250 proceeds to block 760.

In block 760, the reader mode device 110 displays notification of the declined transaction. In an example embodiment, the reader mode device 110 displays the notification on the user interface 111. For example, the reader mode device 110 displays a pop-up window, notification, alert, or other message indicating that the transaction was declined.

In block 770, the reader mode device 110 displays a request to provide new payment account information or to cancel the transaction. In an example embodiment, the reader mode device 110 displays a notification on the user interface 111, prompting the user 101 to cancel the transaction or provide new payment account information. For example, the user 101 is presented with the option to use a credit card with a NFC tag, a magnetic stripe credit card, a coupon, to make a cash payment to the merchant, or to cancel the transaction.

In block 775, the reader mode device 110 determines whether the user 101 has selected to cancel the transaction or provide new payment account information. In an example embodiment, the reader mode device 110 receives the user's 101 selection in response to the request displayed on the reader mode device 110.

If the user 101 provides new payment account information, the method 250 proceeds to block 210 in FIG. 2.

Returning to block 775 of FIG. 6, if the user 101 cancels the transaction, the method 250 proceeds to block 780.

In block 780, the reader mode device 110 displays notification that the transaction was cancelled. For example, the reader mode device 110 displays a pop-up window, notification, alert, or other message indicating that the transaction was cancelled.

The method 250 then proceeds to block 270 of FIG. 2.

Returning to FIG. 2, in block 260, the reader mode device 110 determines whether to initiate a subsequent transaction. In an example embodiment, the reader mode device 110 application 114 determines whether the full purchase price was paid for the purchase transaction. For example, a customer made a purchase for $200 from the merchant, and used one payment device 130 to for a $150 payment. The customer now wants to initiate a second payment transaction to pay the remaining $50 using a second payment device. In another example, the customer decides to buy another item after completing the first payment transaction. In yet another example, the user 101 initiates a second or subsequent payment transaction with a new customer and/or new payment device.

If there is a subsequent transaction, the method 200 proceeds to block 210.

Returning to block 260, if there is not a subsequent transaction, the method 200 proceeds to block 270.

In block 270, the application 114 transmits a receipt to a reader mode device 110. In an example embodiment, the reader mode device 110 receives a receipt for the purchase transaction and transmits the receipt to the payment device 130, prints the receipt, or otherwise transmits the receipt to the user 101. In an example embodiment, the receipt is transmitted to the user's 101 digital wallet account. In an example embodiment, the receipt displays the final status of the payment transaction and comprises a statement with information such as the amount of the transaction, a list of the item(s) purchased along with the price(s), whether the transaction was accepted or declined, the time the transaction was processed, a confirmation number or receipt number, or any other desired, useful or relevant information. In another example embodiment, the receipt is transmitted prior to processing a subsequent transaction. In yet another example embodiment, the receipt is a listing of all transaction processed for a specified period of time.

### Other Example Embodiments

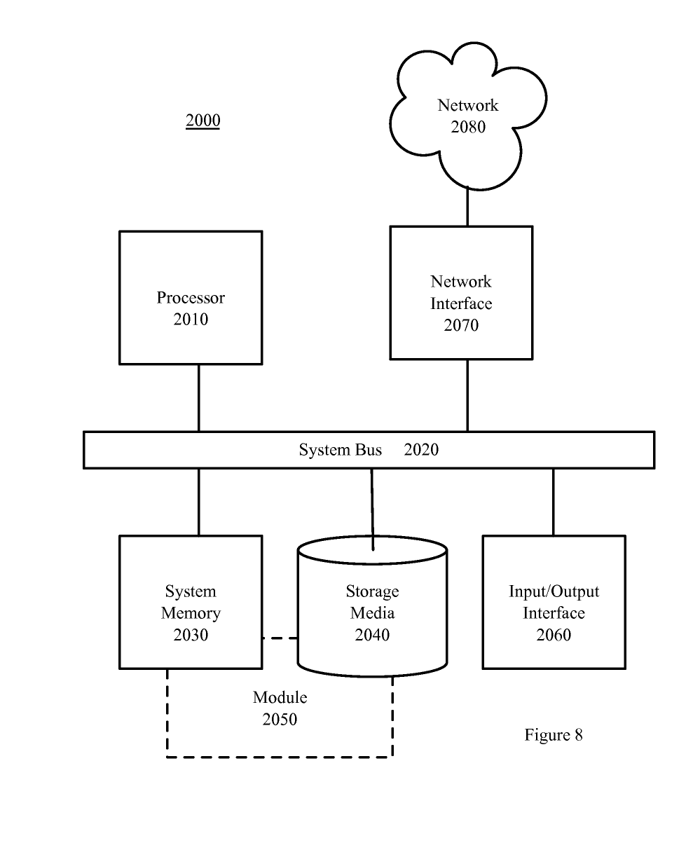

FIG. 8 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (ROM), programmable read-only memory (PROM), erasable programmable read-only memory (EPROM), flash memory, or any other device capable of storing program instructions or data with or without applied power. The system memory 2030 may also include volatile memories such as random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (SOC), system on package (SOP), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method for processing wireless payment transactions, comprising:
receiving, by a computing device, a request to conduct a payment transaction with a payment device, wherein the computing device comprises a secure memory, wherein the payment device comprises an application capable of transmitting payment account information to the computing device via a radio frequency (RF) wireless communication channel, and wherein the computing device and the payment device are separate and distinct;
establishing, by a computing device, an RF wireless communication channel between the computing device and the payment device;
transmitting, by the computing device, a payment reading command to the payment device via the RF wireless communication channel, wherein the payment reading command is transmitted from a secure memory of the computing device and instructs the application on the payment device to transmit encrypted payment account information to the computing device, and wherein the encrypted payment account information comprises financial payment account information and payment account verification information;
receiving, by the computing device, the encrypted payment account information from the payment device, wherein the computing device receives the encrypted information via the secure memory of the computing device;
decrypting, by the computing device, the encrypted payment account information into the secure memory, wherein a secure sub-device of the computing device decrypts the payment account information;
requesting, by the computing device, verification information from a user of the payment device;
verifying, by the computing device, the decrypted payment account information, wherein the computing device verifies the decrypted payment account information via the secure memory of the computing device; and
in response to verifying the payment account information, encrypting, by the computing device, the payment account information by the secure memory of the computing device.

2. The method of claim 1, further comprising transmitting, by the computing device, the encrypted payment account information to one or more computing devices operated by a payment processing system via a cellular network, wherein the one or more computing devices operated by the payment processing system decrypts the encrypted payment account information and process the payment transaction, and wherein an application distinct from the secure memory on the computing device transmits the encrypted payment information.

3. The method of claim 1, wherein the payment verification comprises one or more of a personal identification number, a biometric reading, a bar code, or a magnetic stripe reading.

4. The method of claim 1, wherein verifying the decrypted financial information comprises determining that the payment account verification information matches verification information received from the payment device.

5. The method of claim 1, wherein the payment account information comprises information stored in a secure memory on the payment device.

6. The method of claim 5, wherein the payment device is a smart card and the secure memory on the payment device conforms to Europay, MasterCard, and Visa (EMV) protocols.

7. The method of claim 1, wherein the RF wireless communication channel comprises a near-field communication (NFC) wireless communication channel, a Bluetooth wireless communication channel, or a Wi-Fi wireless communication channel.

8. The method of claim 1, wherein the secure memory in the computing device comprises a secure element.

9. A computer program product, comprising:
a non-transitory computer-readable medium having computer-readable program instructions embodied therein that when executed by a computing device operated by a user cause the computing device to process wireless payment transactions, the computer-readable program instructions comprising:
computer-readable program instructions for receiving a request to conduct a payment transaction with a payment device, wherein the payment device comprises an application capable of transmitting payment account information to the computing device via a radio frequency (RF) wireless communication channel, and wherein the computing device and the payment device are separate and distinct;
computer-readable instructions for transmitting a payment reading command to the payment device via the RF wireless communication channel, wherein the payment reading command is transmitted from a secure memory of the computing device and instructs the application on the payment device to transmit encrypted payment account information to the computing device, and wherein the encrypted payment account information comprises financial payment account information and payment account verification information;
computer-readable instructions for decrypting the encrypted payment account information, wherein the secure memory in the computing device decrypts the payment account information;
computer-readable instructions for verifying the decrypted payment account information wherein the computing device verifies the decrypted payment account information via the secure memory of the computing device; and
computer-readable instructions for encrypting the payment account information by the secure memory.

10. The computer program product of claim 9, further comprising computer-readable program instructions for requesting verification information from a user of the payment device.

11. The computer program product of claim 9, further comprising computer-readable program instructions for transmitting the encrypted payment account information to one or more computing devices operated by a payment processing system via a cellular network, wherein the one or more computing devices operated by the payment processing system decrypts the encrypted payment account information and process the payment transaction.

12. The computer program product of claim 9, wherein verifying the decrypted financial information comprise computer-readable program instructions for determining that the payment account verification information matches verification information received from the payment device.

13. The computer program product of claim 9, wherein the payment account information comprises information stored in a secure memory on the payment device.

14. The computer program product of claim 9, wherein the RF wireless communication channel comprises a near-field communication (NFC) wireless communication channel, a Bluetooth wireless communication channel, or a Wi-Fi wireless communication channel.

15. A system for processing wireless payment transactions, the system comprising:
a storage medium; and
a processor communicatively coupled to the storage medium, wherein the processor executes application code instructions that are stored in the storage medium and that cause the system to:
receive a request to conduct a payment transaction with a payment device, wherein the payment device comprises an application capable of transmitting payment account information to the computing device via a radio frequency (RF) wireless communication channel;
transmit a payment reading command to the payment device via the RF wireless communication channel, wherein the payment reading command is transmitted from a secure memory of the computing device and instructs the application on the payment device to transmit payment account information to the computing device, and wherein the payment account information comprises financial payment account information and payment account verification information;
verify the payment account information using the secure memory of the computing device; and
in response to verifying the payment account information, encrypt the payment account information by the secure memory of the computing device.

16. The system of claim 15, wherein the payment account information received from the payment device is encrypted and wherein the processor is further configured to execute computer-readable instructions stored in the storage medium to decrypt the encrypted payment account information.

17. The system of claim 15, wherein the processor is further configured to execute computer-readable instructions stored in the storage medium to request verification information from a user of the payment device.

18. The system of claim 15, wherein the processor is further configured to execute computer-readable instructions stored in the storage medium to transmit the encrypted payment account information to one or more computing devices operated by a payment processing system via a cellular network, wherein the one or more computing devices operated by the payment processing system decrypts the encrypted payment account information and process the payment transaction.

19. The system of claim 15, wherein the payment account information comprises information stored in a secure memory on the payment device.

20. The system of claim 15, wherein the RF wireless communication channel comprises a near-field communication (NFC) wireless communication channel, a Bluetooth wireless communication channel, or a Wi-Fi wireless communication channel.
